(19) United States
(12) Patent Application Publication
(10) Pub. No.: US 2019/0128468 A1
(43) Pub. Date: May 2, 2019

(54) HEADER SNORKEL

(71) Applicant: Orlande Sivacoe, Lacombe (CA)

(72) Inventor: Orlande Sivacoe, Lacombe (CA)

(21) Appl. No.: 15/825,571

(22) Filed: Nov. 29, 2017

(30) Foreign Application Priority Data
Oct. 26, 2017 (CA) 2983843

(51) Int. Cl. F16L 55/34; F16L 55/179; F16L 55/46; G03B 37/00; G01N 21/954; G01M 3/00

(52) U.S. Cl. CPC F16L 55/34; F16L 55/179; F16L 55/46; F16L 2101/10; G01N 21/954; G01M 3/005; G03B 37/005

(57) ABSTRACT

A pig delivery apparatus for delivering a pig to a feeder pipe connected to a header pipe. The pig delivery apparatus includes an opening configured to connect to a feeder pipe opening and a camera with a field of view arranged to provide a view of the feeder pipe opening ahead of the pig delivery apparatus as the pig delivery apparatus is moved within the header pipe towards alignment with the feeder pipe opening.

### CROSS-REFERENCE TO RELATED APPLICATIONS

This patent application claims the benefit under 35 U.S.C. § 119 of Canadian Patent Application No. 2,983,843, filed Oct. 26, 2017, which application is incorporated herein by reference.

### TECHNICAL FIELD

Pig delivery systems.

### BACKGROUND

U.S. Pat. No. 8,733,187 discloses a pig delivery apparatus for extending into a header pipe to deliver pigs to a feeder pipe. That patent uses a camera within a head piece of the pig delivery apparatus and looking through an opening in the head piece to allow workers to align the opening with the feeder pipe. However, this positioning of the camera necessarily restricts the field of view of the camera to substantially the size of the opening itself. This narrow field of view is inconvenient for the workers aligning the pig delivery apparatus, as when the opening does not overlap with a feeder pipe the workers will generally receive little useful feedback from the camera. That patent also discloses other cameras outside the head piece. However, these cameras are also arranged with fields of view that cover only portions of the header pipe close to the opening of the head piece.

### SUMMARY

There is provided a pig delivery apparatus for a header pipe, the header pipe having an interior surface defining a feeder pipe opening, the header pipe defining a longitudinal direction, a feeder pipe extending from the feeder pipe opening, the pig delivery apparatus having a body defining a rearward opening for connection to a delivery tube, a forward opening, and a passageway connecting the rearward opening to the forward opening, the forward opening arranged to be oriented at an angle to the longitudinal direction for engaging with the feeder pipe opening when the pig delivery apparatus is within the header pipe, the body defining a lateral direction perpendicular to the orientation of the forward opening and perpendicular to the longitudinal direction when the pig delivery apparatus is within the header pipe, the pig delivery apparatus being configured to be moved along the header pipe to a position at which the forward opening is aligned with the feeder pipe opening, a camera mounted to the body and configured to provide, when the pig delivery apparatus is within the header pipe, a field of view including a view of a position on the header pipe surface forward of the pig delivery apparatus in the longitudinal direction and aligned with the forward opening in the lateral direction, and a jack coupled to the body and configured to press the body against the interior surface of the header tube to sealably couple the forward opening with the feeder pipe opening when the pig delivery apparatus is in the position at which the forward opening is aligned with the feeder pipe opening.

In various embodiments, there may be included any one or more of the following features: The field of view may include a view of a position on the header pipe surface forward of the forward opening by at least one times a diameter of the header pipe in the longitudinal direction and aligned with the forward opening in the lateral direction, instead of or in addition to including a position on the header pipe surface forward of the pig delivery apparatus in the longitudinal direction and aligned with the forward opening in the lateral direction; the field of view may also include a view of part of the pig delivery apparatus, and the camera may be mounted on the body in a position displaced from the passageway in the lateral direction.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of an embodiment of a pig delivery apparatus, but not showing a camera;

FIG. 2 is a schematic section view of the pig delivery apparatus of FIG. 1, the section plane being a vertical longitudinal plane;

FIG. 3 is an isometric view of an intersection between a header pipe and a feeder pipe;

FIG. 4 is a schematic end view of the pig delivery apparatus of FIG. 1 showing a camera;

FIG. 5 is a side view of the pig delivery apparatus of FIG. 1 in a cutaway view of a header pipe, showing a camera with a field of view;

FIG. 6 is a top view of a portion of the pig delivery apparatus for mounting a top portion shown in FIG. 7 for coupling with the feeder pipe; and

FIG. 7 is a bottom view of a removable top portion of the pig delivery apparatus.

### DETAILED DESCRIPTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodologies, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

A pig delivery apparatus may be used to deliver a pig to a pipe, and may also be used, depending on the embodiment, to return a pig from a pipe.

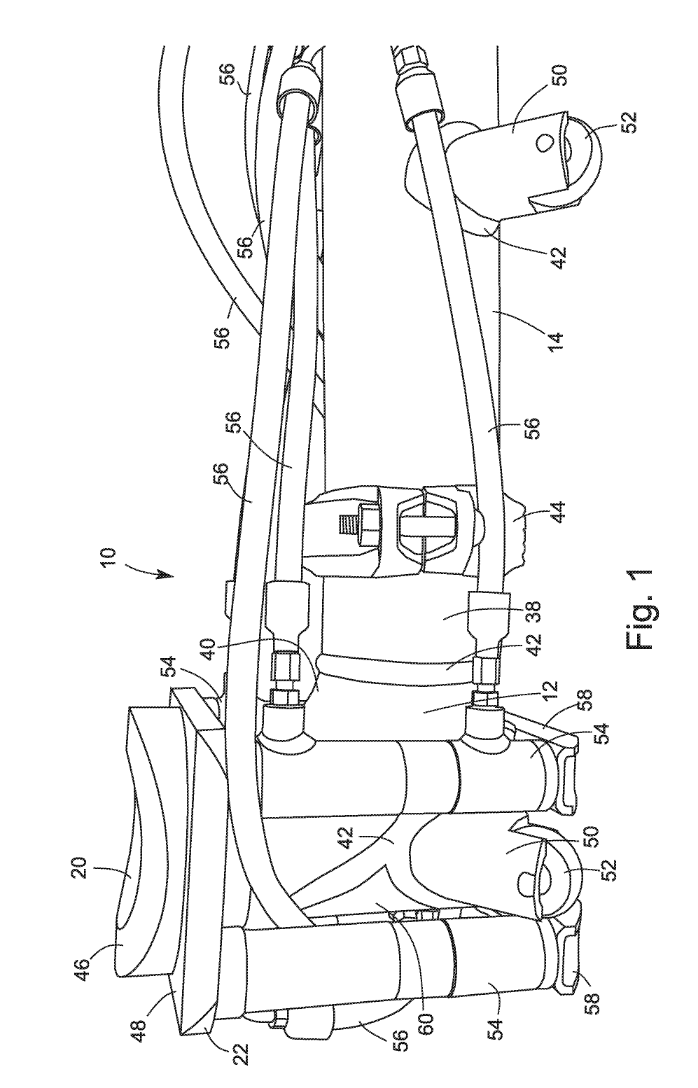

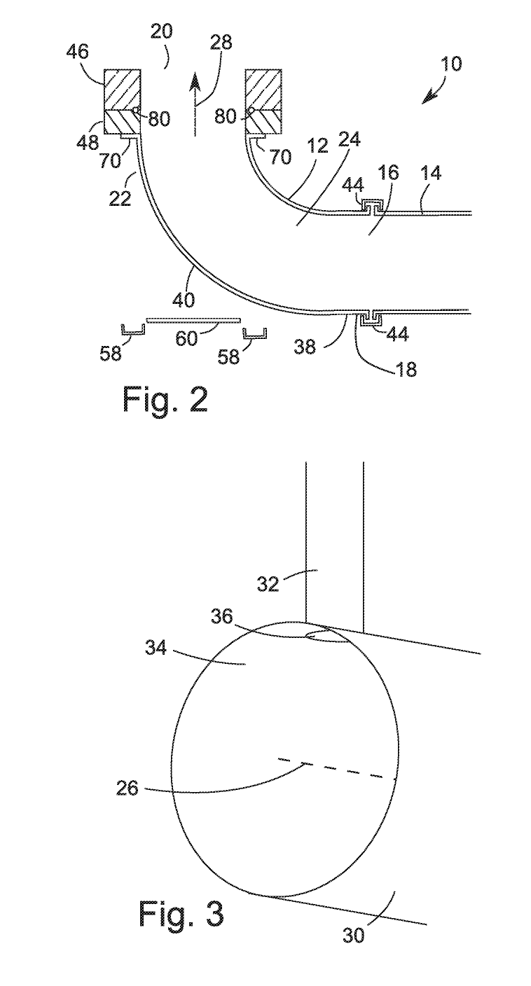

As shown in FIG. 1, a pig delivery apparatus 10 may comprise a body 12 configured to connect to a delivery tube 14. FIG. 2 shows a schematic section view (not to scale) of the pig delivery apparatus of FIG. 1. As shown in FIG. 2, the body 12 defines a rearward opening 16 at a rearward end 18 and a forward opening 20 at a forward end 22. A passageway 24 suitable for a pig to travel through connects the rearward opening 16 to the forward opening 20. The section plane shown in FIG. 2 is taken in a vertical longitudinal direction, the delivery tube 14 defining in this embodiment a central axis lying within the section plane.

FIG. 3 shows a schematic diagram of an intersection of a header pipe 30 with a feeder pipe 32. The feeder pipe 32 extends from a feeder pipe opening 36 defined by an interior surface 34 of the header pipe 30. The header pipe 30 defines a longitudinal direction along the header pipe. If the header pipe defines a central axis, for example as shown in this embodiment and as indicated by dashed line 26, the longitudinal direction will be along the central axis. The delivery tube 14 in this embodiment also defines a central axis, and in this embodiment the delivery tube's central axis is parallel to the central axis of the header pipe when the pig delivery apparatus is within the header pipe.

The forward opening 20 is oriented at an angle to the longitudinal direction, as shown in FIG. 2 by dashed arrow 28. This allows the forward opening to engage with the feeder pipe opening 36. A lateral direction may also be defined as perpendicular to the orientation of the forward opening and also perpendicular to the longitudinal direction when the pig delivery apparatus is within the feeder pipe.

In the embodiment shown in FIGS. 1 and 2, the body 12 comprises a tubular portion 38 welded to a bent tubular portion 40 to form the passageway to the forward opening 20. Welds are indicated with reference numeral 42 in FIG. 1 and are not shown in FIG. 2. In other embodiments, other designs could be used, for example a 90 degree junction could connect parts of the passageway adjacent to the forward and rearward openings. In this embodiment, the rearward opening 16 is connected to the delivery tube 14 using a clamp 44. The rearward opening and delivery tube may be configured to form any suitable tube connection for connecting the rearward opening to the delivery tube.

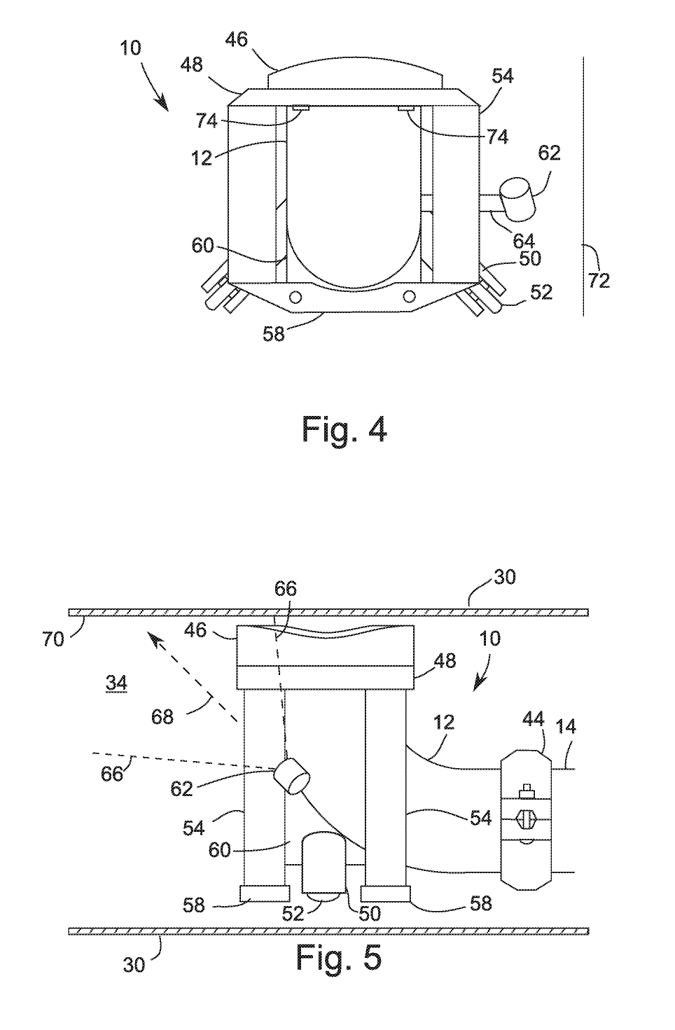

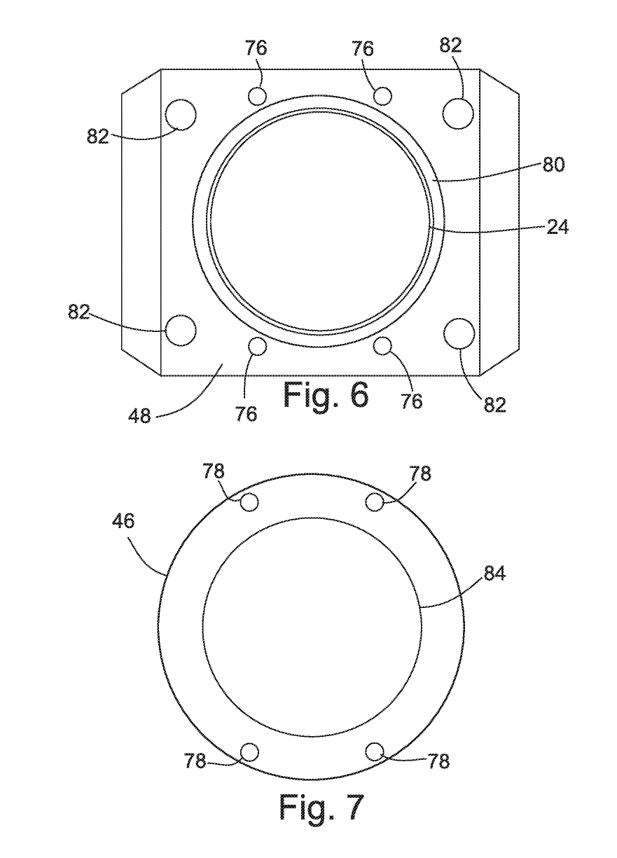

The forward opening 18 is defined in this embodiment by a curved element 46. The curved element 46 is shaped to generally conform to the interior surface 34 of the header pipe 30. In the embodiment shown, the curved element 46 seals against the interior surface 34 of the header pipe 30 around the feeder pipe opening to couple the forward opening to the feeder pipe opening when the body 12 is pressed against the interior surface 34 of the header pipe 30. The seal may be, for example, 1 inch larger in diameter than the feeder pipe opening 36. Imperfections in the fit between the openings may be acceptable so long as the pig (not shown) to be used is sufficiently flexible. The curved element 46 is connected with bent tubular portion 40 in this embodiment by plate 48. The curved element 46 and plate 48 may be connected to a flange 70 of the bent tubular portion 40 with bolts (not shown). Although shown as separate elements, curved element 46 and plate 48 may be formed of a single piece. An “0” ring 80 may be provided to seal between these elements. Additional o-rings (not shown) may also be provided between plate 48 and flange 70, or at clamp 44. The seals should seal against a pressure level which it is desired that the passageway 24 should be able to accommodate, for example 1000 psi. The curved element 46 may be removably attached to plate 48, for example using bolts (not shown in FIG. 1 or 2, but shown as elements 74 in FIG. 4) inserted through holes (not shown in FIG. 1 or 2, but shown as elements 76 in FIG. 6) in plate 48 and screwed into pockets (not shown in FIG. 1 or 2, but shown as elements 78 in FIG. 7) in the curved element 46. By using a removable curved element 46, which can be swapped out for another removable curved element 46 with different curvature, the pig delivery apparatus may be adapted to seal against the internal surface 34 of differently sized header pipes 30.

FIGS. 6 and 7 show the holes 76 and pockets 78. FIG. 6 shows plate 48 from above with the curved element 46 removed. Holes 76 extend through plate 48 to reveive the bolts. Plate 48 also in the embodiment shown has further fasteners such as bolts 82 to connect to the jacks. O-ring 80 rests in a groove in plate 48. FIG. 7 shows curved element 46 from below. Pockets 78 extend partway into curved element 46. Bore 84 extends through curved element 46 to the forward opening 20 which is defined by the opposite side of the curved element than shown in FIG. 7. In the embodiment shown, four pockets and four corresponding holes are used in offset positions so that the curved element 46 can only be attached to plate 48 in proper position.

Support elements 50 may be provided on the body 12 to support the body 12 in the header pipe 30. The support elements 50 may include movement facilitating elements such as bearing wheels 52 so that the pig delivery apparatus can be moved along the header pipe 30 more easily. The delivery tube 14 may also be provided with support elements 50 and movement facilitating elements such as bearing wheels 52. In the embodiment shown a tubular portion 60 is welded to the bent tubular portion 40 and support elements 50 are welded to tubular portion 60. Welds 42 are shown in FIG. 1 but not FIG. 2.

Hydraulic rams 54 are connected to the body 12, in this embodiment via plate 48, to act as jacks to press the body against the interior surface of the header pipe to sealably couple the forward opening 18 with the feeder pipe. Hoses 56 connect the rams to a hydraulic power source (not shown), which may be a hydraulic power pack using for example 110V, 12V, 14V or 240V electrical input to provide hydraulic power. Hoses 56 are shown in FIG. 1 but not shown in FIG. 2. Any other form of jack, such as an inflatable jack or mechanical jack, might also be used. The jack may press a bumper 58 against a portion of the interior surface of the header pipe opposite to the feeder pipe opening in order to press the body 12 towards the interior surface of the header pipe around the feeder pipe. The embodiment shown uses as the bumpers 58 box beams machined to conform with the header pipe interior surface 34. The jacks may provide in an embodiment 8000 lbs of pressure so that the seal may be maintained against pressure in the feeder pipe. In the embodiment shown, there are two bumpers and four jacks, but different numbers of jacks and bumpers may be used, including more or fewer bumpers and jacks or a single bumper and single jack.

The bumpers 58 may be removable so that they can be replaced with differently shaped bumpers to conform with the interior surface of differently sized header pipes. The differently shaped bumpers may also have different lengths and heights. Each of the removable bumpers 58 may be sized and shaped so that it has a portion that conforms with a header pipe of an intended size, and is not in contact with the header pipe interior surface when the jacks 54 are in a minimum length configuration.

FIG. 4 is a schematic diagram showing an end view of a pig delivery apparatus. As shown in FIG. 4, camera 62 is mounted on body 12 to provide a view for an operator of the pig delivery apparatus. In this embodiment, the camera 62 is mounted to the body via bracket 64. Line 72 represents a diameter of the pig delivery apparatus perpendicular to the longitudinal direction in the direction of orientation of the forward opening when the jack is in a contracted configuration. Where the pig forward opening is angled away from the longitudinal direction in a vertical direction, as in the embodiment shown, this diameter is the height of the pig delivery apparatus.

FIG. 5 shows a schematic cutaway view of a header pipe 30 with a side view of a forward portion of the pig delivery apparatus 10 inside the header pipe 30. The camera 62 provides a field of view for example as shown in FIG. 5 by dashed lines 66. The field of view may be centered on a direction, here indicated by dashed arrow 68 oriented at 45 degrees to the longitudinal direction when the pig delivery apparatus is in the header pipe. The field of view includes a portion of the interior surface 34 of the header pipe 30 when the pig delivery apparatus is within the header pipe 30. Reference numeral 70 indicates an example of a particular point on the interior surface of the header pipe that would be in the field of view in this embodiment.

The purpose of the camera on the pig delivery apparatus is to allow a worker to position the pig delivery apparatus to align the forward opening with the feeder pipe opening to couple the forward opening with the feeder pipe opening. A person skilled in the art would likely assume that the camera is only useful for providing a field of view at or adjacent to the forward opening because the person skilled in the art would assume that a worker could easily estimate the distance the pig delivery apparatus needs to be moved within sufficient accuracy that the feeder pipe opening would be within the narrow field of view after moving the pig delivery apparatus the estimated distance. The design of the pig delivery apparatus disclosed in U.S. Pat. No. 8,733,187 appears to reflect such an assumption. The pig delivery apparatus disclosed in that patent includes four cameras: one within the body, two positioned laterally and aligned with the forward opening, and one positioned forward of the forward opening and pointing towards the forward opening (that is, angled rearward). While the field of view of these cameras is not specifically disclosed, it is likely that none of them can view the header pipe surface forward of the forward end of the pig delivery apparatus, and that if they could it would be a small distance forward.

It has been found by experimentation that, in fact, workers move a pig delivery apparatus into alignment more efficiently with the use of visual feedback provided by a camera positioned with a field of view that allows the worker to see the feeder pipe opening well before the pig delivery apparatus reaches the position at which the forward opening is aligned with the feeder pipe opening.

Thus, as shown in FIG. 5, the camera 62 is configured to provide a field view such that the field of view includes at least a part of the feeder pipe opening while the feeder pipe opening is forward of the pig delivery apparatus as the worker moves the pig delivery apparatus within the header pipe towards a position where the forward opening is aligned with the feeder pipe opening. For a pig delivery apparatus configured to move longitudinally within the pipe, the trajectory may be a longitudinal trajectory, and the camera 62 may be configured to provide a field of view including a view of a position on the header pipe surface forward of the pig delivery apparatus in the longitudinal direction and aligned with the forward opening in the lateral direction. The field of view may include, for example, a view of a position 70 on the interior surface 34 of the header pipe that is aligned with the forward opening in the lateral direction and forward of the forward opening by at least 1 times the diameter 72 of the pig delivery apparatus perpendicular to the longitudinal direction in the direction of orientation of the forward opening when the jack is in a contracted configuration, 2 times the diameter of the pig delivery apparatus, 3 times the diameter of the pig delivery apparatus, 4 times the diameter of the pig delivery apparatus, 5 times the diameter of the pig delivery apparatus, 6 times the diameter of the pig delivery apparatus, 7 times the diameter of the pig delivery apparatus, 8 times the diameter of the pig delivery apparatus, 9 times the diameter of the pig delivery apparatus, or 10 times the diameter of the pig delivery apparatus. The field of view may also include a vanishing point corresponding to the longitudinal direction.

When the pig delivery apparatus is in position to couple with a feeder pipe opening, the feeder pipe opening may be out of the field of view of the camera 62 which is located in this embodiment exterior to the body. Thus, a person skilled in the art would likely conclude that in order for a worker to line up the forward opening accurately with the feeder pipe opening, a camera would have to be inside the body, as disclosed in U.S. Pat. No. 8,733,187. However, it has been found by experimentation that this is not the case. That is, it has been found that workers are able to line up the openings with sufficient accuracy even if they cannot see the feeder pipe opening at the point of alignment of the forward opening with the feeder pipe opening. The worker sees at least a part of the feeder pipe opening moving within the field of view as the worker moves the pig delivery apparatus and can estimate how to further move the pig delivery apparatus to achieve alignment with the feeder pipe opening. As shown, the field of view in this embodiment also includes a view of part of the pig delivery apparatus. It is believed that this assists the worker in achieving alignment by enabling the worker to compare the positions of the part of the pig delivery apparatus and the feeder pipe opening as the worker moves the pig delivery apparatus, to help the worker attain an intuitive understanding of the relative positions of the pig delivery apparatus and the feeder pipe opening. It is therefore surmised that if the field of view did not include a part of the pig delivery apparatus, the worker would find it more difficult to achieve alignment. However, it may be that sufficient practice or training could overcome this difficulty, or an image of the pig delivery apparatus could simply be mounted next to a screen showing the view from the camera, to show the position of the pig delivery apparatus relative to the view shown in the screen. In the embodiment shown in the figures, the camera 62 includes a part of the pig delivery apparatus regardless of whether the jacks are in a contracted or extended configuration, because the part of the pig delivery apparatus that is in the field of view is not movable with respect to the camera. In other embodiments, the camera may be connected to a bumper or jack. In this case, preferably there is a part of the body in the field of view at least when the jacks are in a contracted configuration.

Some deviation from mathematically perfect alignment may be tolerated as pigs are made to be flexible to accommodate bends in pipes. This flexibility can also accommodate some deviation in alignment or other issues with the fit between the forward opening and the feeder pipe opening. Therefore the term “alignment” as used here does not refer to perfect alignment but to practical alignment.

In the embodiment shown in FIG. 4, the camera 62 is mounted laterally from the body. A person skilled in the art might assume that the camera should be mounted in a position relative to the body that is coplanar with the longitudinal direction and the forward opening to provide a symmetric view of the feeder pipe opening. However, it has been found by experimentation that workers are able to use the camera oriented in such a side position to achieve alignment. Moreover, for a given viewing angle of the camera, the side position provides better field of view than an end position would have (as the side position will, depending on the orientation of the camera, provide a field of view including a greater length of pipe or with a rearward edge further rearward and thus closer to, and perhaps including, the forward opening).

The camera 62 may have a field of view centered in a direction with less than 90 degrees of vertical tilt from a forward longitudinal direction, and in particular may have a field of view centered in a direction with about 45 degrees of vertical tilt from a forward longitudinal direction, for example between 35 degrees and 55 degrees of vertical tilt from the forward longitudinal direction, between 30 degrees and 60 degrees of vertical tilt from the forward longitudinal direction, between 25 degrees and 65 degrees of vertical tilt from the forward longitudinal direction, between 20 degrees and 70 degrees of vertical tilt from the forward longitudinal direction, or between 15 degrees and 75 degrees of vertical tilt from the forward longitudinal direction. A camera pointing forward with no vertical tilt may also work, but is less preferred. The field of view may also optionally be centered at a horizontal angle from the forward longitudinal direction. For embodiments where the forward opening is not oriented vertically away from the longitudinal direction, the direction away from the longitudinal direction of the orientation of the forward opening should be substituted for “vertical” in this paragraph, and the lateral direction for “horizontal”.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A pig delivery apparatus comprising:
a contact element defining a contact surface shaped to conform with an interior surface of a header pipe, the contact element defining a forward opening in the contact surface and defining a bore extending though the contact element to the forward opening, the header pipe defining a longitudinal direction, the interior surface of the header pipe defining a feeder pipe opening, a feeder pipe extending from the feeder pipe opening;
a body connected to the contact element, the body defining a rearward opening for connection to a delivery tube and a passageway connecting the rearward opening to the bore defined by the contact element, the contact element and body being arranged to orient the forward opening at an angle to the longitudinal direction for engaging with the feeder pipe opening when the pig delivery apparatus is within the header pipe, the contact element and body defining a lateral direction perpendicular to the orientation of the forward opening and perpendicular to the longitudinal direction when the pig delivery apparatus is within the header pipe;
the pig delivery apparatus being configured to be moved along the header pipe to a position at which the forward opening is aligned with the feeder pipe opening;
a camera mounted to the body and configured to provide, when the pig delivery apparatus is within the header pipe, a field of view including a view of a position on the header pipe surface aligned with the forward opening in the lateral direction and forward of the pig delivery apparatus in the longitudinal direction; and
a jack coupled to the body and configured to press the body against the interior surface of the header pipe to sealably couple the forward opening with the feeder pipe opening when the pig delivery apparatus is in the position at which the forward opening is aligned with the feeder pipe opening.

2. The pig delivery apparatus of claim 1 in which the contact element is removably connected to the body.

3. The pig delivery apparatus of claim 2 in which the contact element is connected to the body using bolts.

4. The pig delivery apparatus of claim 3 in which the contact element defines pockets and a portion of the body defines corresponding holes, and the bolts extend into the pockets through the holes.

5. The pig delivery apparatus of claim 2 further comprising a bumper shaped for conforming with the header pipe and removably connected to the jack.

6. The pig delivery apparatus of claim 1 in which the field of view also includes a view of part of the pig delivery apparatus when the jack is in a contracted configuration.

7. The pig delivery apparatus of claim 1 in which the camera is mounted on the body in a position displaced from the passageway in the lateral direction.

8. A pig delivery apparatus comprising:
a contact element defining a contact surface shaped to conform with an interior surface of a header pipe, the contact element defining a forward opening in the contact surface and defining a bore extending though the contact element to the forward opening, the header pipe defining a longitudinal direction, the interior surface of the header pipe defining a feeder pipe opening, a feeder pipe extending from the feeder pipe opening;
a body connected to the contact element, the body defining a rearward opening for connection to a delivery tube and a passageway connecting the rearward opening to the bore defined by the contact element, the contact element and body being arranged to orient the forward opening at an angle to the longitudinal direction for engaging with the feeder pipe opening when the pig delivery apparatus is within the header pipe, the contact element and body defining a lateral direction perpendicular to the orientation of the forward opening and perpendicular to the longitudinal direction when the pig delivery apparatus is within the header pipe;
the pig delivery apparatus being configured to be moved along the header pipe to a position at which the forward opening is aligned with the feeder pipe opening;
a jack coupled to the body and configured to press the body against the interior surface of the header pipe to sealably couple the forward opening with the feeder pipe opening when the pig delivery apparatus is in the position at which the forward opening is aligned with the feeder pipe opening; and
a camera mounted to the body and configured to provide, when the pig delivery apparatus is within the header pipe, a field of view including a view of a position on the header pipe surface aligned with the forward opening in the lateral direction and forward of the forward opening in the longitudinal direction by at least one times a diameter of the pig delivery apparatus perpendicular to the longitudinal direction in the direction of orientation of the forward opening when the jack is in a contracted configuration.

9. The pig delivery apparatus of claim 8 in which the contact element is removably connected to the body.

10. The pig delivery apparatus of claim 9 in which the contact element is connected to the body using bolts.

11. The pig delivery apparatus of claim 10 in which the contact element defines pockets and a portion of the body defines corresponding holes, and the bolts extend into the pockets through the holes.

12. The pig delivery apparatus of claim 9 further comprising a bumper shaped for conforming with the header pipe and removably connected to the jack.

13. The pig delivery apparatus of claim 8 in which the field of view also includes a view of part of the pig delivery apparatus when the jack is in a contracted configuration.

14. The pig delivery apparatus of claim 8 in which the camera is mounted on the body in a position displaced from the passageway in the lateral direction.

15. The pig delivery apparatus of claim 8 in which the position on the header pipe surface is forward of the forward opening by at least five times the diameter of the pig delivery apparatus.
